(19) United States
(12) Patent Application Publication
(10) Pub. No.: US 2026/0361459 A1
(43) Pub. Date: Nov. 12, 2026

(54) METHOD AND ELECTRONIC DEVICE FOR PILOTLESS COMMUNICATION

(71) Applicant: POSTECH RESEARCH AND BUSINESS DEVELOPMENT FOUNDATION, Pohang-si (KR)

(72) Inventor: Nam Yoon LEE, Pohang-si (KR)

(73) Assignee: POSTECH RESEARCH AND BUSINESS DEVELOPMENT FOUNDATION, Pohang-si (KR)

(21) Appl. No.: 19/358,711

(22) Filed: Oct. 15, 2025

(30) Foreign Application Priority Data
May 8, 2025 (KR) 10-2025-0059997
Jul. 23, 2025 (KR) 10-2025-0099817

(51) Int. Cl. H04L 1/00; H04L 25/02; H04L 27/20

(52) U.S. Cl. CPC H04L 1/0058; H04L 25/0202; H04L 27/201

(57) ABSTRACT

A method and electronic device for pilotless communication are provided. The method for pilotless communication includes applying a first modulation to first coded bits, to obtain first modulated bits, and applying a second modulation to second coded bits, to obtain second modulated bits. The first modulation and the second modulation are different modulation methods. The method for pilotless communication includes estimating a channel by using a first received signal and performing a decoding operation on the first received signal and a second received signal by using the estimated channel.

### CROSS-REFERENCE TO RELATED APPLICATIONS

This application is based on and claims priority under 35 U.S.C. § 119 to Korean Patent Application No. 10-2025-0059997, filed on May 8, 2025, and Korean Patent Application No. 10-2025-0099817, filed on Jul. 23, 2025, in the Korean Intellectual Property Office, the disclosures of which are incorporated by reference herein in their entirety.

### BACKGROUND

### 1. Field

The disclosure relates to communications, and more particularly, to methods and electronic devices for pilotless communications.

This research was supported by the Samsung Future Technology Promotion Project (Project Number: SRFC-IT2302-04).

### 2. Description of the Related Art

In communication systems, channel estimation is essential for signal recovery at a receiver. A technique is being used in which the receiver estimates a channel based on a pilot signal transmitted from a transmitter. However, this method requires allocating some of the total transmission symbols as a pilot, which reduces the number of valid data symbols. Accordingly, there is a disadvantage in that pilot overhead occurs and an effective code rate decreases.

To solve these issues, a pilot-free communications technique using differential modulation was proposed. However, this method has a disadvantage of a large signal-to-noise ratio (SNR) loss. Additionally, a technique for superimposing a pilot signal onto a data signal through power control has been proposed. However, this method has a disadvantage of delay due to iteration and the need to set a pilot length long to ensure orthogonality with the data signal.

### SUMMARY

Provided are a method and electronic device for pilotless communication. Additionally, provided are a method and electronic device for pilotless communication, which may be utilized for code extension.

Additional aspects will be set forth in part in the description which follows and, in part, will be apparent from the description, or may be learned by practice of the presented embodiments of the disclosure.

A method for pilotless communication, according to an embodiment, includes performing an encoding operation on information bits, to obtain coded bits, applying a first modulation to first coded bits including a first subset of the coded bits, to obtain first modulated bits, and applying a second modulation different from the first modulation, to second coded bits including a second subset of the coded bits, to obtain second modulated bits, wherein the applying of the first modulation includes mapping the first coded bits to a column vector or a row vector of a matrix.

In an embodiment, the mapping may include mapping the first coded bits to the column vector of the matrix indexed according to values of the first coded bits, or mapping the first coded bits to the row vector of the matrix indexed according to the values of the first coded bits.

In an embodiment, the mapping may include mapping the first coded bits to a binary vector in which an element at a position indexed according to values of the first coded bits is 1 and the remaining elements are 0, and generating the first modulated bits by multiplying the matrix by the binary vector.

In an embodiment, the first modulation and the second modulation may have a same set of symbol values.

In an embodiment, a number of symbols mapped to the first coded bits in the first modulation may be different from a number of symbols mapped to the second coded bits in the second modulation.

In an embodiment, the matrix may include a unitary matrix or an orthogonal matrix.

In an embodiment, the mapping may include mapping the first coded bits to a row vector of a unitary matrix.

In an embodiment, a length of the first modulated bits may be twice a length of the first coded bits.

In an embodiment, the second modulation may include binary phase shift keying (BPSK) modulation.

An electronic device for pilotless communication, according to an embodiment, includes a memory storing instructions, and a processor configured to execute the instructions, wherein, by executing the instructions, the processor is configured to perform an encoding operation on information bits, to obtain coded bits, apply a first modulation to first coded bits including a first subset of the coded bits, to obtain first modulated bits, and apply a second modulation different from the first modulation to second coded bits including a second subset of the coded bits, to obtain second modulated bits, and the processor is further configured to, by executing the instructions, map the first coded bits to a column vector or a row vector of a matrix.

A method for pilotless communication, according to an embodiment, includes estimating a channel by using a first received signal including a first subset of received signals, and performing, to obtain information bits, by using the estimated channel, a decoding operation on the first received signal and a second received signal including a second subset of the received signal, wherein the information bits include first information bits decoded from the first received signal and second information bits decoded from the second received signal.

In an embodiment, the estimating of the channel may include applying a linear transformation to the first received signal without changing a mean and variance of noise included in the first received signal, estimating a mean of the transformed first received signal, and estimating the channel to minimize an estimation error, based on the estimated mean of the first received signal.

In an embodiment, the applying of the linear transformation may include applying a unitary matrix to the first received signal.

In an embodiment, the estimating of the mean may include determining a mean of elements of the transformed first received signal.

In an embodiment, the estimating of the channel to minimize the estimation error may include estimating the channel to minimize a mean square error between the channel and the estimated channel, based on the estimated mean of the first received signal.

In an embodiment, the performing of the decoding operation may include determining a log likelihood ratio (LLR) of the first received signal, based on the estimated channel, determining an LLR of the second received signal, based on the estimated channel, and obtaining the information bits by performing the decoding operation based on the LLR of the first received signal and the LLR of the second received signal.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a transmission structure according to the related art;

FIG. 2 illustrates a system according to an embodiment;

FIG. 3 is a flowchart of an operating method of a transmitter, according to an embodiment;

FIG. 4 illustrates operation of a transmitter according to an embodiment;

FIG. 5 illustrates a first modulation operation of a transmitter, according to an embodiment;

FIG. 6 is a flowchart of an operating method of a receiver, according to an embodiment;

FIG. 7 illustrates operation of a receiver, according to an embodiment;

FIG. 8 illustrates a channel estimation operation of a receiver, according to an embodiment; and

FIG. 9 illustrates a decoding operation of a receiver, according to an embodiment.

### DETAILED DESCRIPTION

Reference will now be made in detail to embodiments, examples of which are illustrated in the accompanying diagrams, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The advantages and features of the disclosed embodiments and methods of achieving the advantages and features will be described more fully with reference to the embodiments described below together with the accompanying drawings. The disclosure may, however, be embodied in many different forms and should not be construed as being limited to the embodiments set forth herein; rather these embodiments are provided so that this disclosure will be thorough and complete, and will fully convey the concept of the disclosure to one of ordinary skill in the art.

It will be understood that each block in the flowchart may be performed by computer program instructions. These computer program instructions may be installed in a processor of a general-purpose computer, a special-purpose computer, or other programmable data processing equipment, and thus the instructions, when executed by the processor of the computer or other programmable data processing equipment, generate a means for performing the functions described in the block(s). These computer program instructions may also be stored in a computer-executable or computer-readable memory that may direct a computer or other programmable data processing equipment to function in a particular manner, such that the instructions stored in the computer-executable or computer-readable memory may produce a manufactured article including instruction means that perform the functions specified in the flowchart block(s). The computer program instructions may also be installed on a computer or other programmable data processing equipment, such that, by executing a series of operations on the computer or other programmable data processing equipment, a process executed on the computer is generated. The instructions that cause the computer or other programmable data processing equipment to operate may further provide steps for performing the functions described in the block(s). Additionally, each block may represent a module, segment, or portion of code that contains one or more executable instructions for executing a particular logical function(s).

The terms used in this specification will be briefly described, and then the disclosure will be described in detail.

The terms used in this specification are those general terms currently widely used in the art in consideration of functions in regard to the disclosure, but the terms may vary according to the intention of those of ordinary skill in the art, precedents, or new technology in the art. Also, specified terms may be selected by the applicant, and in this case, the detailed meaning thereof will be described in the detailed description of the disclosure. Thus, the terms used in the specification should be understood not as simple names but based on the meaning of the terms and the overall description of the disclosure.

In the disclosure

$${𝔽}_{2}^{k}$$

is a set of sequences of length k, and each element of which is either 0 or 1. For example,

$${𝔽}_{2}^{2} = \{ 00 , 01 , 10 , 11 \} .$$

In the disclosure [symbol] ^{k} is a set of sequences of length k, and each element of which is a real number.

In the disclosure, {−1,1}^{k} is a set of sequences of length k and each element consisting of −1 or 1. For example, {−1,1}²={[1,1], [1, 1], [1,1], [1,1]}.

In the disclosure [symbol] is a set of real numbers.

In the disclosure, the expression “at least one of a, b, or c” may refer to “a”, “b”, “c”, “a and b”, “a and c”, “b and c”, “all of a, b, and c”, or variations thereof.

In the present specification, singular expressions include plural expressions unless the context clearly specifies that they are singular.

Throughout the specification, it will also be understood that when a component “includes” an element, unless there is another opposite description thereto, it should be understood that the component does not exclude another element but may further include another element.

The term “processor” should be interpreted broadly to include general-purpose processors, central processing units (CPUs), microprocessors, digital signal processors (DSPs), controllers, microcontrollers, state machines, and the like. In some environments, “processor” may also refer to an application-specific integrated circuit (ASIC), a programmable logic device (PLD), a field-programmable gate array (FPGA), etc. The term “processor” may also refer to a combination of processing devices, such as, for example, a combination of a DSP and a microprocessor, a combination of a plurality of microprocessors, a combination of one or more microprocessors in conjunction with a DSP core, or any other such combination of components.

The term “memory” should be interpreted broadly to include any electronic component capable of storing electronic information. The term “memory” may also refer to various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, registers, etc. A memory is said to be in electronic communication with the processor if the processor may read information from the memory and/or write information to the memory. A memory integrated into the processor is in electronic communication with the processor.

Various embodiments are described with reference to the accompanying drawings.

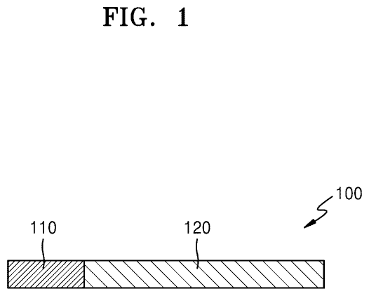

FIG. 1 illustrates a transmission structure according to the related art.

A transmitter encodes information bits to generate coded bits and modulates the coded bits to generate data symbols. For example, the transmitter encodes information bits of length K to generate coded bits of length N_{d}.

The transmitter generates a frame 100 including a pilot 110 and data 120. For example, the transmitter generates the frame 100 including the data 120 of length N_{d} and the pilot 110 of length Nₚ.

A receiver receives the frame 100 that has passed through a channel and performs decoding using a log-likelihood ratio (LLR)-based decoder. Channel estimation is essential for LLR-based decoding. The pilot 110 is used for channel estimation of the receiver, and the data 120 is decoded based on the estimated channel.

If there is no pilot 110 in the frame 100, the effective code rate is K/N_{d}. However, as the frame 100 includes the pilot 110 for channel estimation, the effective sub-efficiency is reduced to K/(N_{d}+N_{d}). Accordingly, the ratio of actual information bits in the frame 100 decreases, and the data transmission efficiency of the system decreases.

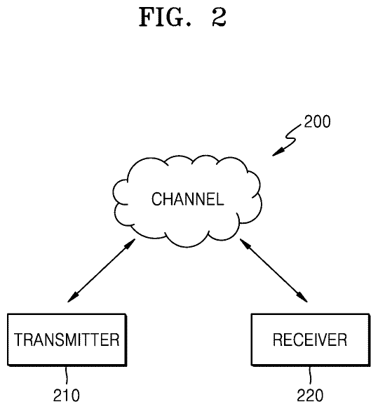

FIG. 2 illustrates a system 200 according to an embodiment.

The system 200 may include a transmitter 210 and a receiver 220 that communicate with each other through a channel. Each of the transmitter 210 and the receiver 220 may be an electronic device including a processor and memory.

Each of the transmitter 210 and the receiver 220 may be applied to various electronic devices. As a non-limiting example, each of the transmitter 210 and the receiver 220 may be applied to a computing device, a robot, a smart TV, a smart tablet, a smartphone, a medical device, a mobile device, a video display device, a measuring device, an Internet of Things (IoT) device, a digital camera, or a vehicle.

The transmitter 210 and the receiver 220 may communicate without a pilot. The transmitter 210 may transmit a pilotless frame to the receiver 220 through a channel. The receiver 220 may receive the pilotless frame, estimate a channel based on the frame, and then decode data.

The processor of the transmitter 210 may control the overall operations of the transmitter 210. For example, the processor may control the overall operations of the transmitter 210 to perform communication by executing one or more instructions of a program stored in the memory. Additionally, the same description may be applied to the receiver 220.

The functions of the transmitter 210 may be executed by the processor of the transmitter 210. Accordingly, the operations described as being performed by the transmitter 210 in the disclosure may actually be performed by the processor. Additionally, the same description may be applied to the receiver 220.

Each of the transmitter 210 and the receiver 220 may include a communication interface. The communication interface of the transmitter 210 may perform data communication with the receiver 220 under the control by the processor. Additionally, the same description may be applied to the receiver 220.

The transmitter 210 and the receiver 220 may perform data communication with each other using at least one of data communication methods including wired local area network (LAN), wireless LAN, Wi-Fi, Bluetooth, Zigbee, Wi-Fi Direct (WFD), infrared data association (IrDA), Bluetooth low energy (BLE), near field communication (NFC), wireless broadband internet (Wibro), world interoperability for microwave access (WiMAX), shared wireless access protocol (SWAP), wireless gigabit alliances (WiGig), or radio frequency (RF) communication. The data communication method of the transmitter 210 and the receiver 220 is not limited thereto.

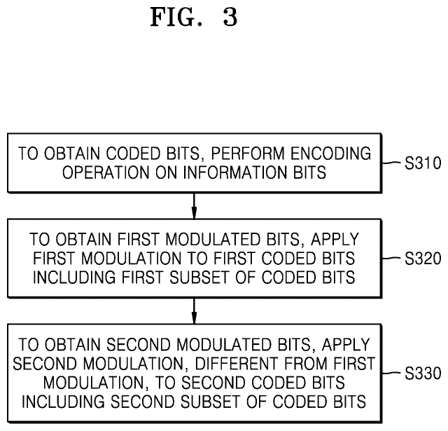

FIG. 3 is a flowchart of an operating method of a transmitter, according to an embodiment.

FIG. 3 illustrates an operating method of a transmitter for communicating without a pilot. This method may also be used for code extension.

In operation S310, the transmitter performs an encoding operation on information bits to obtain coded bits.

The transmitter may generate information bits by inserting appropriate parity bits into coded bits. Parity bits may help a receiver to smoothly recover a received signal.

In operation S320, the transmitter applies a first modulation to first coded bits including a first subset of coded bits, to obtain first modulated bits.

The transmitter may split the coded bits into first coded bits and second coded bits. The first coded bits may include a first subset of coded bits, and the second coded bits may include a second subset of coded bits. Here, the first subset and the second subset may be mutually exclusive sets. Additionally, the union of the first subset and the second subset may be equal to the entire set of coded bits.

The first modulated bits may be for data demodulation and channel estimation of the receiver. As the first modulated bits are generated from the information bits, the first modulated bits are not pilots and correspond to data.

The transmitter may perform the first modulation by mapping a first coded bit to a column vector or a row vector of a matrix. In detail, the transmitter may map the first coded bit to a column vector of a matrix indexed according to a value of the first coded bits, or map the first coded bit to a row vector of a matrix indexed according to the value of the first coded bit. For example, if the first coded bit is 0, the first coded bit may be mapped to a first row vector of a 2×2 matrix, and if the first coded bit is 1, the first coded bit may be mapped to a second row vector of the 2×2 matrix.

The transmitter may perform mapping to a matrix by multiplying the matrix by a binary vector. In detail, the transmitter may generate a binary vector in which elements at positions indexed by the value of the first coded bit are 1 and the elements at the remaining positions are 0. A binary vector may be referred to as a one-hot vector. The transmitter may generate the first modulated bits by multiplying the matrix by the binary vector.

The matrix used in the first modulation may be, but is not limited to, a unitary matrix or an orthogonal matrix. These matrices are matrices that become identity matrices when multiplied by a conjugate transpose matrix or a transpose matrix, and this property may be used by the receiver to estimate a channel. Additionally, linear transformations using these matrices do not affect the statistical properties of the Gaussian distribution, which may be used by the receiver to estimate a channel.

In operation S330, the transmitter applies a second modulation, different from the first modulation, to the second coded bits including the second subset of coded bits, to obtain second modulated bits.

If the first modulated bits are for data demodulation and channel estimation of the receiver, the second modulation may be for data demodulation of the receiver. Accordingly, the second modulation is a modulation method different from the first modulation, and various data modulation methods may be used for the second modulation. For example, the second modulation may include, but is not limited to, binary phase shift keying (BPSK) modulation.

As the first modulation is performed by mapping the first coded bit to a matrix, the number of symbols mapped to the first coded bit may be determined by the size of the matrix. The number of symbols mapped to the second coded bits may be determined based on the data modulation method used for the second modulation. Therefore, depending on the design, the number of symbols mapped to the first coded bit in the first modulation and the number of symbols mapped to the second coded bit in the second modulation may be the same or different.

The symbol values of the first modulation may be determined by the element values of the matrix used for the first modulation. The symbol values of the second modulation may be determined based on the data modulation method used for the second modulation. Therefore, depending on the design, the first modulation and the second modulation may have the same set of symbol values or different sets of symbol values.

The transmitter may generate a transmitted signal by combining the first modulated bits with the second modulated bits. The transmitted signal may be transmitted to the receiver through a channel.

The operating method of the transmitter described above may also be used for code extension. By generating coded bits including the first coded bits and the second coded bits, the transmitter may generate a codeword having a length increased by the length of the first coded bits from the length of the second coded bits.

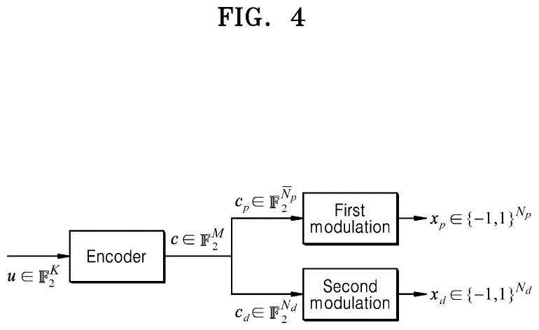

FIG. 4 illustrates operation of a transmitter, according to an embodiment.

In an embodiment, the transmitter encodes information bits (u) of length K to generate coded bits (c) of length M. The transmitter splits the coded bits (c) of length N̅ₚ into first coded bits (cₚ) of length N_{d} and second coded bits (c_{d}) of length N_{d}. Here, M=N̅_{p+Nd}.

The transmitter performs the first modulation on the first coded bits (cₚ) to generate first modulated bits (xₚ) of length Nₚ. In an embodiment, the transmitter generates the first modulated bits (xₚ) by performing a mapping to a column vector of a Hadamard matrix. For example, a first coded bit 0 may be mapped to a first column vector of an H₂ matrix, and a first coded bit 1 may be mapped to a second column vector of the H₂ matrix. Here, the H₂ matrix is

$$[ \begin{matrix}1 & 1 \\ 1 & - 1\end{matrix} ] .$$

A modulated bit x_{p,i} for an ith coded bit c_{p,i} may be summarized as shown in Table 1.

TABLE 1

| first coded bit (C_{p, i}) | first modulated bit (X_{p, i}) |
|---|---|
| 0 | [1, 1]^{T} |
| 1 | [1, −1]^{T} |

In an embodiment, as the H₂ matrix is used in the first modulation, the number of symbols mapped to one bit of the first modulated bits (xₚ) is 2, and the symbol values of the first modulation are −1 and 1. Also, the length Nₚ of the first modulated bits (xₚ) is twice the length N̅ₚ of the first coded bits (cₚ). The transmitter performs the second modulation on the second coded bits (c_{d}) to generate second modulated bits (x_{d}). In an embodiment, the transmitter generates the second modulated bits (x_{d}) using BPSK modulation as the second modulation.

In an embodiment, since BPSK modulation is used for the second modulation, the number of symbols mapped to one bit of the second coded bits (x_{d}) is 1, and the symbol values of the second modulation are −1 and 1. Accordingly, the first modulation and the second modulation have the same set of symbol values. When the first modulation and the second modulation have the same set of symbol values, a common basis may be formed in the first modulation and the second modulation, and thus, the circuit design of the transmitter and the receiver may be performed efficiently.

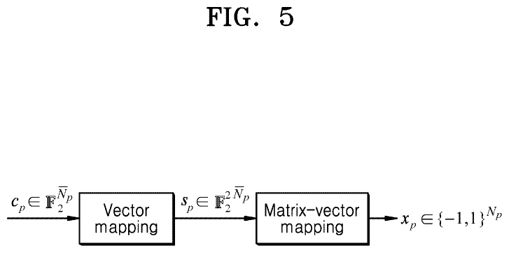

FIG. 5 illustrates a first modulation operation of a transmitter, according to an embodiment.

In an embodiment, the transmitter performs vector mapping on the first coded bits (cₚ). The transmitter maps the first coded bits (cₚ) to a binary vector (sₚ). For example, the first coded bit 0 may be mapped to [1,0]^{T}, and the first coded bit 1 may be mapped to [0,1]^{T}.

In an embodiment, the transmitter performs vector mapping by multiplying the H₂ matrix by a binary vector. A first column of the H₂ matrix may be selected as a result of multiplying the H₂ matrix by [1,0] T. Additionally, the second column of the H₂ matrix may be selected as a result of multiplying the H₂ matrix by [0, 1] T.

The vector mapping of the ith coded bit c_{p,i} may be summarized as shown in Table 2.

TABLE 2

| C_{p, i} | S_{p, i} | X_{p, i} |
|---|---|---|
| 0 | [1, 0]^{T} | [1, 1]^{T} |
| 1 | [0, 1]^{T} | [1, −1]^{T} |

Additionally, the modulated bit x_{p,i} corresponding to the ith coded bit c_{p,i} may be expressed as in Mathematical Equation 1.

x_{p,i}=H₂s_{p,i} [Mathematical Equation 1]

Here, s_{p,i} is a binary vector corresponding to the ith coded bit c_{p,i}.

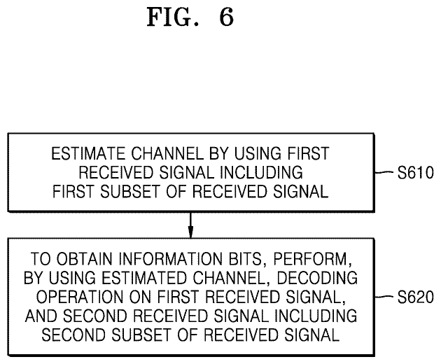

FIG. 6 is a flowchart of an operating method of a receiver, according to an embodiment.

In operation S610, the receiver estimates a channel by using a first received signal including a first subset of a received signal.

The receiver may receive a received signal, which is a transmitted signal of a transmitted, which has passed through a channel. The received signal y may be expressed as in Mathematical Equation 2.

y=hx+v [Mathematical Equation 2]

Here, h is a mathematical representation of a channel, which may be referred to as a channel, a channel coefficient, or a fading coefficient. x is a transmitted signal and v is noise. Noise (v) follows a Gaussian distribution. The statistical distribution of the noise (v) may be represented as in Mathematical Expression 3.

v~ [symbol] (0,σ²) [Mathematical Expression 3]

A received signal may include a first received signal and a second received signal. The first received signal may include a first subset of the received signal, and the second received signal may include a second subset of the received signal. Here, the first subset and the second subset may be mutually exclusive sets. The first received signal may be a signal received at the receiver, the signal being mixed with noise generated when the first modulated bits of the transmitter pass through the channel. Similarly, the second received signal may be a signal corresponding to the second modulated bits of the transmitter.

The receiver may estimate a channel by processing the first received signal. In detail, the receiver may apply a linear transformation to the first received signal, estimate a mean of the transformed first received signal, and then estimate a channel to minimize an estimation error, based on the estimated mean.

For linear transformation, the inverse matrix of the matrix used in the first modulation of the transmitter may be used. For example, if the matrix used in the first modulation is a unitary matrix (or an orthogonal matrix), the receiver may perform a linear transformation by multiplying the first received signal by a conjugate transpose matrix of the unitary matrix (or a transpose matrix of the orthogonal matrix). Due to the properties of the unitary and orthogonal matrices, the statistical distribution of noise included in the first received signal may not change according to the linear transformation.

As the inverse matrix of the matrix used in the first modulation of the transmitter is applied to the first received signal, the channel coefficients are present in the first received signal that is transformed into a form multiplied by a binary vector. Therefore, by estimating the mean of the transformed first received signal by adding the elements of the transformed first received signal and dividing the same by the number of elements, channel information, i.e., statistical distribution of channel coefficients, may be obtained.

Once the statistical distribution of the channel coefficients is obtained, the receiver may find the estimated channel in a direction that minimizes the mean square error between the actual channel and the estimated channel.

In operation S620, to obtain information bits, the receiver performs, by using the estimated channel, a decoding operation on the first received signal and the second received signal including the second subset of the received signal.

LLR is information that probabilistically evaluates which bit a received signal is more likely to correspond to, and channel estimation is essential for calculating LLR. The receiver may determine the LLR of the first received signal and the LLR of the second received signal based on the estimated channel. Additionally, the receiver may estimate information bits by performing a decoding operation based on the LLR of the first received signal and the LLR of the second received signal.

In the operating method described above, as the receiver estimates a channel without changing the statistical distribution (mean and variance) of noise, the same level of channel estimation accuracy as a pilot-based channel estimation technique may be provided. Additionally, the channel estimation process of the receiver has the same level of channel estimation complexity as the pilot-based channel estimation technique. Additionally, as the first received signal corresponds to a data signal, the effective code rate is not reduced due to pilot overhead.

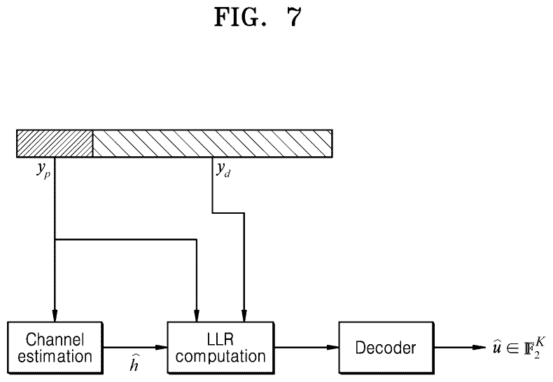

FIG. 7 illustrates operation of a receiver, according to an embodiment.

In an embodiment, the receiver estimates information bits of length K from a received signal. The estimated information bits are indicated as û. The received signal includes a first received signal (yₚ) and a second received signal (y_{d}). The first received signal (yₚ) corresponding to the first modulated bits may be expressed as in Mathematical Equation 4.

yₚ=hxₚ+vₚ[Mathematical Equation 4]

Here, h is a channel, xₚ are the first modulated bits, and vₚ is noise added to the first modulated bits as the first modulated bits pass through the channel.

The second received signal (y_{d}) corresponding to the second modulated bits may be expressed as in Mathematical Equation 5.

y_{d}=hx_{d}+v_{d}[Mathematical Equation 5]

Here, h is a channel, x_{d} are the second modulated bits, and v_{d} is noise added to the second modulated bits as the second modulated bits pass through the channel.

The receiver estimates a channel using the first received signal (yₚ). The estimated channel is indicated as ĥ. The receiver calculates the LLR of the first received signal (yₚ) and the LLR of the second received signal (y_{d}) by using the channel ĥ.

In an embodiment, symbol values of the first modulation of the transmitter are −1 and 1 and symbol values of the second modulation are −1 and 1. As the first modulation and the second modulation use common symbol values, calculation of the LLR of the first received signal (yₚ) and the second received signal (y_{d}) may be commonly expressed as in Mathematical Equation 6.

$${LLR}_{i} = \frac{P ( {y}_{i} \vert {x}_{i} = + 1 ; \hat{h} )}{P ( {y}_{i} \vert {x}_{i} = - 1 ; \hat{h} )} \qquad [ Mathematical Equation 6 ]$$

Here, yᵢ is the ith element of the received signal, and xᵢ is the ith element of the modulated bits.

The receiver may estimate information bits by decoding the first received signal (yₚ) and the second received signal (y_{d}) by using the LLR of the first received signal (yₚ) and the LLR of the second received signal (y_{d}).

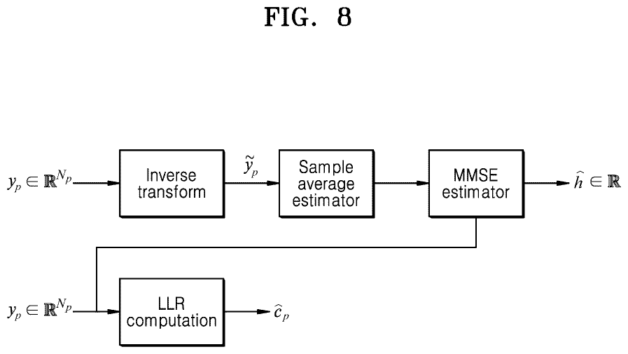

FIG. 8 illustrates a channel estimation operation of a receiver, according to an embodiment.

The receiver performs a linear transformation by applying an inverse matrix of the matrix used in the first modulation of the transmitter, to the first received signal (yₚ). When a unitary matrix is used in the first modulation, the first received signal (yₚ) may be multiplied by a conjugate transpose matrix (U^{T}) of the unitary matrix. Accordingly, the transformed first received signal (\tilde{y}ₚ) may be expressed as in Mathematical Equation 7.

\tilde{y}ₚ=U^{T}yₚ=U^{T}(hxₚ+vₚ)=hsₚ+\tilde{v}ₚ [Mathematical Equation 7]

Here,

$${\tilde{v}}_{p} = {U}^{T} {v}_{p} .$$

Since noise (vₚ) follows a Gaussian distribution, the distribution thereof (mean and variance) does not change even when multiplied by the conjugate transpose matrix (U^{T}) of the unitary matrix. That is, noise (vₚ) and linearly transformed noise (\tilde{v}ₚ) have the same statistical distribution. The term of the first modulated bits (xₚ) remains as a term of a binary vector (sₚ) as the first modulated bits are multiplied by the conjugate transpose matrix (U^{T}) of the unitary matrix.

The receiver estimates a mean of the transformed first received signal (\tilde{y}ₚ). The receiver determines a mean of elements of the transformed first received signal (\tilde{y}ₚ), which may be expressed as in Mathematical Equation 8.

$$\frac{1}{{N}_{p}} {\sum }_{i = 1}^{{N}_{p}} {\tilde{y}}_{p , i} = h + \frac{1}{N} {\sum }_{i = 1}^{{N}_{p}} {\tilde{v}}_{p , i} \qquad [ Mathematical Equation 8 ]$$

As the channel h is included in the first received signal (\tilde{y}ₚ) which is transformed into a form multiplied by the binary vector (sₚ), and the statistical distribution of the noise term (\tilde{y}ₚ) is known, by averaging the transformed first received signal (\tilde{y}ₚ), the statistical distribution of the channel h may be estimated. The estimated statistical distribution of the channel h may be expressed as in Mathematical Expression 9.

$$h \sim 𝒩 ( 0 , {σ}_{h}^{2} )$$

The receiver may estimate the channel h by performing minimum mean squared error (MMSE) estimation based on the statistical distribution of the channel h. The estimated channel ĥ may be expressed as in Mathematical Equation 10.

$$\hat{h} = \frac{{N}_{p} {σ}_{h}^{2}}{{N}_{p} {σ}_{h}^{2} + {σ}^{2}} ( {\sum }_{i = 1}^{{N}_{p}} \frac{1}{{N}_{p}} {\tilde{y}}_{p , i} ) \qquad [ Mathematical Equation 10 ]$$

The receiver may estimate the first coded bits of the transmitter by calculating the LLR of the first received signal (yₚ) by using the estimated channel ĥ. The estimated first coded bits are indicated as ĉₚ.

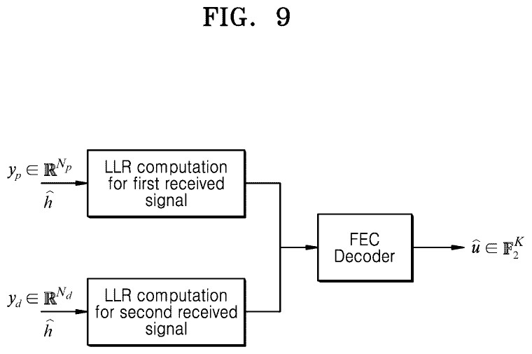

FIG. 9 illustrates a decoding operation of a receiver, according to an embodiment.

The receiver may calculate the LLR of the first received signal (yₚ) by using the estimated channel ĥ. The LLR of the first received signal (yₚ) may be calculated as in Mathematical Equation 11.

$$LLR ( {c}_{i} ) = log \frac{p ( {y}_{p , i} \vert {c}_{p , i} = 1 )}{p ( {y}_{p , i} \vert {c}_{p , i} = 0 )} = log \frac{{e}^{- \frac{{‖ {y}_{p , i} - \hat{h} [ 1 , - 1 ] ‖}_{2}^{2}}{{σ}^{2}}}}{{e}^{- \frac{{‖ {y}_{p , i} - \hat{h} [ 1 , 1 ] ‖}_{2}^{2}}{{σ}^{2}}}} \qquad [ Mathematical Equation 11 ]$$

The receiver may calculate the LLR of the second received signal (y_{d}) by using the estimated channel ĥ. The LLR of the second received signal (y_{d}) may be calculated as in Mathematical Equation 12.

$$LLR ( {c}_{i} ) = log \frac{p ( {y}_{d , i} \vert {c}_{d , i} = 1 )}{p ( {y}_{d , i} \vert {c}_{d , i} = 0 )} = log \frac{{e}^{- \frac{{‖ {y}_{d , i} - \hat{h} [ 1 , - 1 ] ‖}_{2}^{2}}{{σ}^{2}}}}{{e}^{- \frac{{‖ {y}_{d , i} - \hat{h} [ 1 , 1 ] ‖}_{2}^{2}}{{σ}^{2}}}} \qquad [ Mathematical Equation 12 ]$$

The receiver may decode the received signal based on the LLR of the first received signal (yₚ) and the LLR of the second received signal (y_{d}). In an embodiment, the receiver may perform forward error correction (FEC) decoding. The receiver may perform FEC decoding with high reliability by using soft information based on the LLR of the first received signal (yₚ) and the LLR of the second received signal (y_{d}).

The method described above may be recorded on a computer-readable recording medium having recorded thereon one or more programs including commands for executing the method. Examples of the computer-readable recording medium may include magnetic media such as hard disks, floppy disks, and magnetic tape, optical media such as CD-ROMs and DVDs, magneto-optical media such as floptical disks, and hardware devices specifically configured to store and execute program instructions, such as read-only memory (ROM), random access memory (RAM), and flash memory. Examples of program instructions include machine language code, such as that produced by a compiler, as well as high-level language code that may be executed by a computer using an interpreter or the like.

While the disclosure has been particularly shown and described with reference to embodiments thereof, it will be understood by those of ordinary skill in the art that various changes in form and details may be made therein without departing from the spirit and scope of the disclosure as defined by the appended claims. Therefore, the embodiments should be considered in a descriptive sense only and not for purposes of limitation. For example, each element described as a single type may be distributed, and similarly, elements described to be distributed may be combined.

The scope of the disclosure is defined not by the detailed description of the disclosure but by the appended claims, and all differences within the scope will be construed as being included in the disclosure.

According to the embodiments, by performing pilotless communication between a transmitter and a receiver, a reduction in effective code rate due to pilot overhead does not occur.

In addition, according to the embodiments, a communication method having the same level of channel estimation accuracy and channel estimation complexity as a pilot-based channel estimation technique may be provided.

Additionally, according to the embodiments, codewords for channel estimation and data transmission may be utilized for code extension.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method for pilotless communication, the method comprising:
performing an encoding operation on information bits, to obtain coded bits;
applying a first modulation to first coded bits comprising a first subset of the coded bits, to obtain first modulated bits; and
applying a second modulation different from the first modulation, to second coded bits comprising a second subset of the coded bits, to obtain second modulated bits,
wherein the applying of the first modulation comprises mapping the first coded bits to a column vector or a row vector of a matrix.

2. The method of claim 1, wherein the mapping comprises mapping the first coded bits to the column vector of the matrix indexed according to values of the first coded bits, or mapping the first coded bits to the row vector of the matrix indexed according to the values of the first coded bits.

3. The method of claim 1, wherein the mapping comprises:
mapping the first coded bits to a binary vector in which an element at a position indexed according to values of the first coded bits is 1 and the remaining elements are 0; and
generating the first modulated bits by multiplying the matrix by the binary vector.

4. The method of claim 1, wherein the first modulation and the second modulation have a same set of symbol values.

5. The method of claim 1, wherein a number of symbols mapped to the first coded bits in the first modulation is different from a number of symbols mapped to the second coded bits in the second modulation.

6. The method of claim 1, wherein the matrix comprises a unitary matrix or an orthogonal matrix.

7. The method of claim 1, wherein the mapping comprises mapping the first coded bits to a row vector of a unitary matrix.

8. The method of claim 1, wherein a length of the first modulated bits is twice a length of the first coded bits.

9. The method of claim 1, wherein the second modulation comprises binary phase shift keying (BPSK) modulation.

10. An electronic device for pilotless communication, the electronic device comprising:
a memory storing instructions; and
a processor configured to execute the instructions,
wherein, by executing the instructions, the processor is configured to:
perform an encoding operation on information bits, to obtain coded bits;
apply a first modulation to first coded bits comprising a first subset of the coded bits, to obtain first modulated bits; and
apply a second modulation different from the first modulation to second coded bits comprising a second subset of the coded bits, to obtain second modulated bits,
and the processor is further configured to, by executing the instructions, map the first coded bits to a column vector or a row vector of a matrix.

11. A method for pilotless communication, the method comprising:
estimating a channel by using a first received signal comprising a first subset of received signals; and
performing, to obtain information bits, by using the estimated channel, a decoding operation on the first received signal and a second received signal comprising a second subset of the received signal,
wherein the information bits comprise first information bits decoded from the first received signal and second information bits decoded from the second received signal.

12. The method of claim 11, wherein the estimating of the channel comprises:
applying a linear transformation to the first received signal without changing a mean and variance of noise included in the first received signal;
estimating a mean of the transformed first received signal; and
estimating the channel to minimize an estimation error, based on the estimated mean of the first received signal.

13. The method of claim 12, wherein the applying of the linear transformation comprises applying a unitary matrix to the first received signal.

14. The method of claim 12, wherein the estimating of the mean comprises determining a mean of elements of the transformed first received signal.

15. The method of claim 12, wherein the estimating of the channel to minimize the estimation error comprises estimating the channel to minimize a mean square error between the channel and the estimated channel, based on the estimated mean of the first received signal.

16. The method of claim 11, wherein the performing of the decoding operation comprises:
determining a log likelihood ratio (LLR) of the first received signal, based on the estimated channel;
determining an LLR of the second received signal, based on the estimated channel; and
obtaining the information bits by performing the decoding operation based on the LLR of the first received signal and the LLR of the second received signal.
